(19) United States
(12) Patent Application Publication
(10) Pub. No.: US 2006/0193379 A1
(43) Pub. Date: Aug. 31, 2006

(54) System and method for achieving inter-layer video quality scalability

(75) Inventors: Justin Ridge, Irving, TX (US); Yiliang Bao, Irving, TX (US); Marta Karczewicz, Irving, TX (US); Xianglin Wang, Irving, TX (US)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/066,784

(22) Filed: Feb. 25, 2005

(51) Int. Cl. H04N 11/04

(52) U.S. Cl. 375/240.01

(57) ABSTRACT

A system and method for providing quality scalability in a video stream. A bit stream is provided with a video sequence having a base layer and an enhancement layer. The enhancement layer includes a plurality of enhancement layer blocks, each of which includes a block coefficient. Each layer block coefficient is assigned to one of a plurality of zones, and layer block coefficients assigned to a particular one of the plurality of zones are removed periodically.

### FIELD OF THE INVENTION

The present invention relates generally to video coding. More particularly, the present invention relates to scalable video coding for use in electronic devices.

### BACKGROUND OF THE INVENTION

Conventional video coding standards (e.g., MPEG-1, H.261/263/264, etc.) involve encoding a video sequence according to a particular bit rate target. Once encoded, the standards do not provide a mechanism for transmitting or decoding the video sequence at a different bit rate setting than the one used for encoding. Consequently, when a lower bit rate version is required, computational effort must be at least partially devoted to decoding and re-encoding the video sequence.

Quality scalability (also referred to as peak signal-to-noise ratio (PSNR) scalability) in the context of video coding is achieved by truncating an encoded video bit stream so that a lower bit rate version of the encoded sequence is produced. The sequence may be decoded with an associated decrease in quality.

In contrast, with scalable video coding, the video sequence is encoded in a manner such that an encoded sequence characterized by a lower bit rate can be produced simply through manipulation of the bit stream, particularly through the selective removal of bits from the bit stream. Fine granularity scalability (FGS) is a type of scalability that can allow the bit rate of the video stream to be adjusted more or less arbitrarily within certain limits. The MPEG-21 SVC standard requires that the bit rate be adjustable in steps of 10%.

A number of conventional layered coders achieve quality scalability by producing a bit stream having a “base layer” and one or more “enhancement layers” that progressively refine the quality of the next-lower layer towards the original signal. The quality of the decoded signal may therefore be adjusted by removing some or all of the enhancement layers from the bit stream.

One problem associated with layered coding, however, is a lack of “granularity.” If a single enhancement layer is intended to provide only a marginal increase in quality compared to the next-lower layer, coding efficiency tends to be poor. Consequently, such conventional layered coders tend to produce a small number of well-separated (in terms of bit rate) layers. In other words, bit rates/qualities between two layers cannot be easily achieved through bit stream truncation.

As discussed above, a new MPEG-21 Scalable Video Coding standard. should be capable of decoding video in 10% rate increments. As a result, a dichotomy exists: achieving acceptable compression efficiency necessitates few well-spaced layers, yet the FGS requirement necessitates more closely-spaced layers.

In layered coders, it has been proposed to use well-known FGS techniques, used in previous video coding standards, to encode signal-to-noise ratio (SNR) enhancement layers. The drawback of this approach is that, when operating in a low delay (i.e. uni-directional prediction) mode, the performance penalty is on the order of 9 dB for some sequences.

### SUMMARY OF THE INVENTION

The present invention involves the achievement of quality scalability by taking a “top down” approach, where data is removed from an enhancement layer until a given target rate is met, with the potential drop in rate being bounded by the base layer. This approach is substantially the opposite of conventional “bottom up” approaches, where a given layer is taken and are provided with coding enhancements using known FGS techniques, with an upper bound being placed on quality based upon the next layer. Use of the present invention improves the overall coding efficiency while addressing the dichotomy described above.

According to the present invention, a rate decrease is achieved by removing coefficient values from the enhancement layer. A zonal technique is used for removal, where coefficients in one frequency range are removed first, coefficients in a second frequency range are removed next, etc. The sizes and number of the zones may be configured at the time of encoding and indicated to the decoder via signaling bits, or may be dynamically inferred based on spectral or motion characteristics of previously encoded/decoded data. The decision regarding which coefficients to remove is not necessarily made on a frame-by-frame basis. For example, rather than dropping “zone 1” coefficients from every macroblock (MB) in a frame, it may be decided to drop “zone 1” and “zone 2” coefficients from some macroblocks and none from others. This decision may be either explicitly signaled to the decoder in the bit stream, or may be based on a mathematical formula. A mathematical formula could imply a simple periodic function (e.g., only drop “zone 1” from every fourth macroblock), or it could involve inference based on data previously encoded/decoded.

To counter drift, an intra-coded macroblock (or a macroblock encoded without dependency on temporally neighboring data) is inserted occasionally. This is referred to as a “refresh.” The “refresh” may be encoded into the bit stream periodically (i.e., every n frames), or after a number of frames that varies dynamically based on previously encoded/decoded data. The “refresh” need not be sent at the same time for all macroblocks within a frame, e.g., half could be refreshed in one frame and half in the next. The “refresh” period could also vary by zone.

The quality of the “diminished” enhancement layer is bounded by the base layer. This is achieved by limiting the number of frames where drift exists (referred to as the number of “drift frames”). Once the limit has been reached, the enhancement layer is totally disregarded (i.e., only the base layer is used) until the next refresh. A limit on the number of “drift frames” could be signaled in the bit stream. A limit on the number of “drift frames” could also be arrived at using an interval-based approach. In this approach, an interval is maintained for each base layer coefficient at the decoder, and whenever an enhancement layer coefficient strays outside of the interval, the equivalent base layer coefficient is known to be more accurate, and is thus used until the next refresh occurs.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation of an enhancement layer according to one embodiment of the present invention having a plurality of enhancement layer blocks, each being assigned to one of multiple zones;

FIG. 2 is a representation of an enhancement layer where, the boundary between individual zones is determined at the encoder and signaled in the bit stream;

FIG. 3 is a flow diagram showing a generic process for the implementation of the present invention;

FIG. 4 is a perspective view of a mobile telephone that can be used in the implementation of the present invention; and

FIG. 5 is a schematic representation of the telephone circuitry of the mobile telephone of FIG. 4.

### DETAILED DESCRIPTION OF THE PREFERRED EMBODIMENTS

The present invention involves the use of a “top down” method for achieving inter-layer video quality scalability, where data is removed from an enhancement layer until a given rate target is met, with the potential drop in quality bounded by the base layer.

The present invention can be divided into four general areas. Each is discussed as follows.

Zone Identification

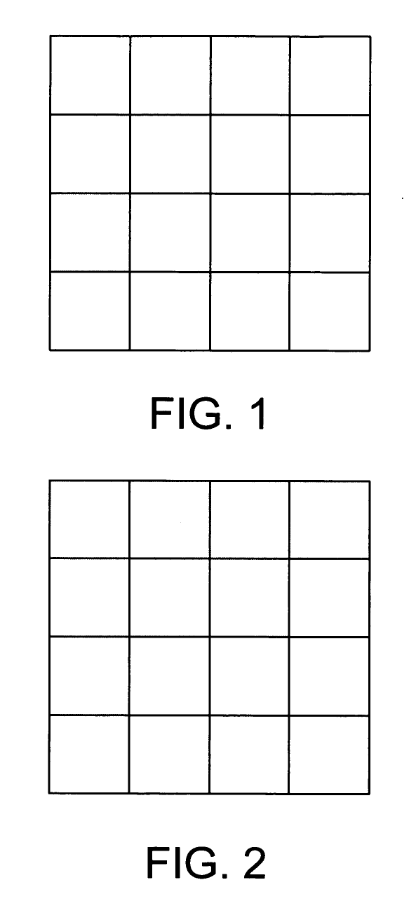

In zone identification, the coefficients from each enhancement layer block are each assigned to one of several “zones.” The simplest implementation involves a fixed number of zones and assigns coefficients to the zones based solely on their position within the block of coefficients. For example, a 4×4 block with two zones may look as is shown in FIG. 1. It should be noted, however, that more than two zones can be used as necessary or desired.

In the embodiment represented in FIG. 1, coefficients in the “grey” locations are assigned to zone 0, and coefficients in the “white” locations are assigned to zone 1. To obtain a full-quality enhancement layer, both zones 0 and 1 are transmitted and decoded. A reduced-quality enhancement, on the other hand, is received by dropping coefficients from zone 1, and only transmitting/decoding coefficients from zone 0. Coefficients from zone 1 are simply replaced by their base layer counterparts.

In one embodiment of the invention, the individual zones are not hard-coded as depicted in FIG. 1. In this situation, the boundary between zones is determined at the encoder and is signaled in the bit stream, e.g. in the sequence or slice header. An alternative zone boundary is shown in FIG. 2.

In another embodiment of the invention, the zones neither remain static within a sequence/slice, nor are the boundaries signaled explicitly in the bit stream. Instead, zones are contracted or expanded based upon previously coded data. For example, in one implementation of the present invention, the energy in the highest-frequency coefficient of zone 0 and the lowest-frequency coefficient of zone 1 are compared over the course of n blocks. If the zone 1 coefficient has greater energy than zone 0, then it is moved from zone 1 to zone 0. Additionally, if two zones consistently contain only zero coefficients, they are merged into a single zone. In this situation, limits are imposed on the size and number of zones so that the desired granularity of scalability can be achieved. These limits are determined based upon the granularity target and the individual sequence characteristics.

In the context of zones, the reordering of coefficients can also be accomplished by zones, instead of by block, in the bit stream. For example, instead of encoding by Block0/Zone0 followed by Block0/Zone1, Block1/Zone0, Block1/Zone1, for the simple removal of zones, the bit stream can be reordered as Block0/Zone0, Block1/Zone0, Block0/Zone1, Block1/Zone1.

Zone Removal

Having developed a technique for grouping coefficients into “zones,” quality scalability is achieved by removing zones from the bit stream.

In one embodiment of the invention, all coefficients are removed from the bit stream starting with a particular zone, e.g., all zone 1 and zone 2 coefficients. As more zones are removed, the bit rate and quality of the resulting decoded sequence is correspondingly lowered.

An alternative embodiment of the invention involves the introduction of periodicity, so that zones are dropped periodically. For example, to achieve a given rate target, zone 1 may be dropped from every block of coefficients, but zone 0 may only be dropped from every second block (or alternatively, from every block of every second frame). Such periodicity can be incorporated into the codec design, or it could be signaled in the bit stream.

Another embodiment of the invention involves the explicit signaling of the zones to be dropped on a shorter temporal basis, such as in the slice header. For example, in a given frame it may be desirable to drop zone 1 coefficients, in a second frame it may be desirable to drop nothing, and in a third frame to drop both zones 0 and 1 (i.e. everything, in the case of a two-zone structure). The decision as to what zones are dropped to achieve a given rate target could be made by the encoder, for example, by following well-known RD-optimization principles.

Still another embodiment of the invention involves the variation of the zones to be dropped, but the zones are dropped based on previously encoded/decoded data, rather than explicit signaling. For example, when there is low motion and neighboring blocks were also dropped, dropping of zones in the current block may be inferred. An “in-between” approach involves signaling the zones to be dropped as described in above, but encoding such signals into the bit stream using a context-based arithmetic coder, where the context selection depends upon data from neighboring blocks.

It should be noted that when a zone of coefficients is removed, it may be replaced with zeros, with the equivalent base layer coefficients, or with coefficients predicted from the base layer. In one embodiment of the present invention, this is a fixed design choice. However, this could also be signaled in the bit stream.

Refreshing

Drift occurs when the encoder and decoder produce different predicted versions of a given block. Because the enhancement layer is encoded with the assumption that all data is available, but the data in some zones may be dropped in order to achieve a bit rate target, the decoder will experience drift. To counter this phenomenon, a macroblock that is either intra-coded, or predicted from the base layer, is inserted from time to time. This is referred to herein as a “refresh.” Such blocks are expensive in terms of coding efficiency, so it is desirable to limit the number of them.

In one implementation of the present invention, refresh macroblocks are sent periodically, e.g., every n frames. Alternatively, the period may differ according to the zone. For example, a refresh for zone 0 coefficients may occur every n0=4 frames, but a refresh for zone 1 coefficients may occur every n1=8 frames.

In another embodiment of the invention, the period may not be constant, but may be determined based on characteristics of the video sequence, specifically the amount of motion. Changes to the period may be signaled in the bit stream, or changes may be inferred based on previously observed motion and spectral characteristics.

In yet another embodiment of the invention, a “phase” may be applied to spread the refresh macroblocks over a number of frames. For example, if the refresh “period” for zone 0 is 2 frames, half may be refreshed in one frame, and the other half refreshed in the next frame.

Base Layer Bounding

In the absence of a “refresh,” drift accumulates over time, eroding the reconstructed sequence quality. It is possible that, at some point, dropping zones from the enhancement layer causes the reconstructed quality to drop below that of the base layer.

To remedy this phenomena, it is desirable to stop using the enhancement layer once it is no longer helpful, and simply decode the base layer until the next refresh occurs.

One implementation of this remedy is for the encoder to signal the number of “allowable drift frames” that the decoder should tolerate before switching to the base layer until the next refresh. Another option involves the use of an interval-based approach. For example, one can take the reconstructed value of a base layer coefficient, and construct an interval around it in which the original coefficient is known to reside. If fully decoded, the equivalent reconstructed enhancement layer coefficient also resides in this interval.

However, if only partially decoded, drift may cause the enhancement layer reconstruction to stray outside of the interval. In this case, the base layer representation is more accurate than the drift-prone enhancement layer. Therefore, base layer coefficients are used until the next “refresh.” Alternatively, one can identify those coefficients from the base layer where the prediction error was zero, and when predicting the enhancement layer, only use the enhancement layer as a reference for the coefficients so identified.

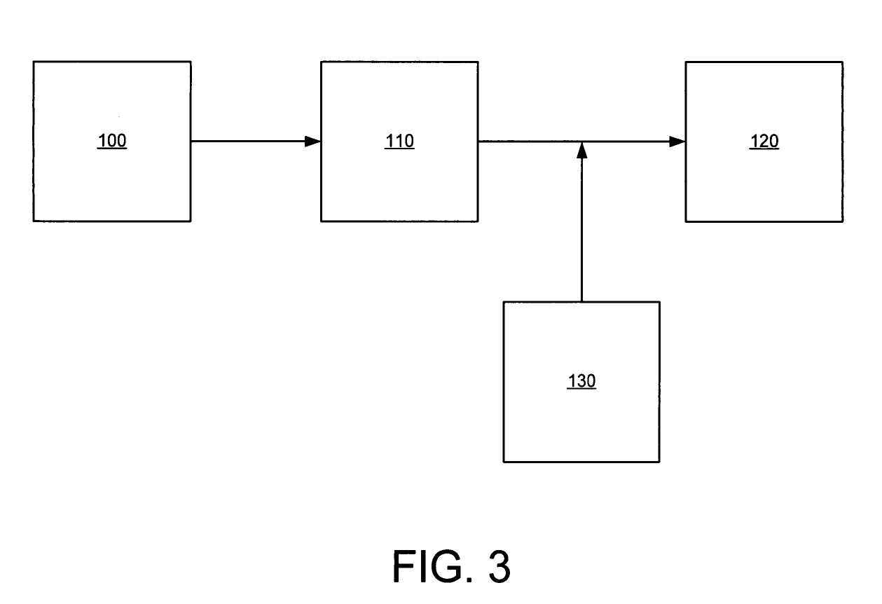

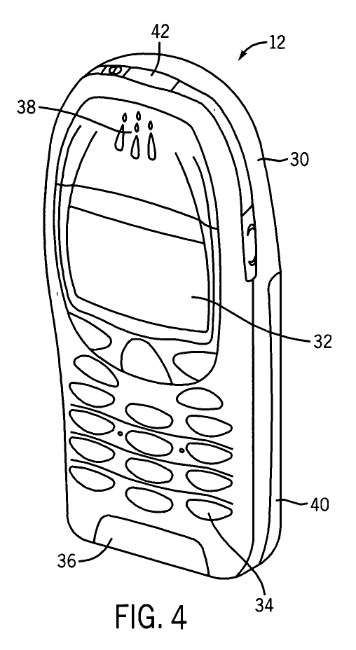

FIG. 3 shows a flow chart showing a generic process for implementing the present invention. At step 100, an enhancement layer and a base layer are provided, with the enhancement layer including a plurality of enhancement layer blocks. At step 110, the coefficients from each enhancement layer block are assigned to a particular zone. At step 120, at least one zone is removed from the enhancement layer as discussed above. At step 130, the enhancement is refreshed, while at step 140, the base layer is decoded as necessary. All of these steps involve the use of the systems and processes described above.

As noted above, embodiments within the scope of the present invention include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above are also to be included within the scope of computer-readable media. Computer-executable instructions comprise, for example, instructions and data which cause a general purpose computer, special purpose computer, or special purpose processing device to perform a certain function or group of functions. Any common programming language, such as C or C++, or assembly language, can be used to implement the invention.

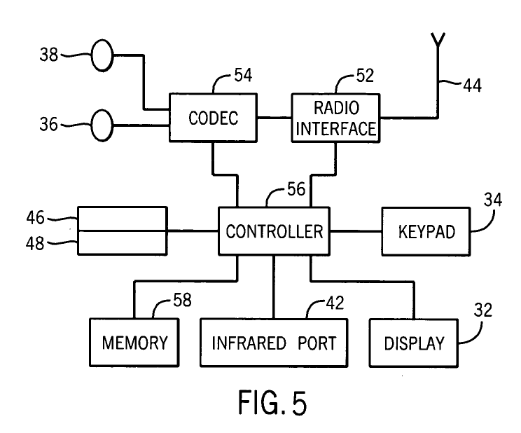

FIGS. 4 and 5 show one representative mobile telephone 12 upon which the present invention may be implemented. However, it is important to note that the present invention is not limited to any type of electronic device and could be incorporated into devices such as personal digital assistants, personal computers, mobile telephones, and other devices. It should be understood that the present invention could be incorporated on a wide variety of mobile telephones 12. The mobile telephone 12 of FIGS. 4 and 5 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module” as used herein and in the claims is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of providing quality scalability in a video stream, comprising the steps of:
providing a bit stream with a video sequence having a base layer and an enhancement layer, the enhancement layer including a plurality of enhancement layer blocks, each enhancement layer block having a plurality of layer block coefficients;
assigning each layer block coefficient to one of a plurality of zones; and
removing the layer block coefficients assigned to a particular one of the plurality of zones.

2. The method of claim 1, wherein the number of layer block coefficients belonging to a zone is signaled within the bit stream.

3. The method of claim 1, wherein the number of layer block coefficients belonging to a zone is determined dynamically based upon previously encoded or decoded data.

4. The method of claim 1, wherein the layer block coefficients belonging to one more zones are removed periodically.

5. The method of claim 4, wherein the period according to which zones are removed differs by zone.

6. The method of claim 1, wherein the layer block coefficients belonging to one or more zones that are removed are removed based upon previously encoded or decoded data.

7. The method of claim 1, wherein the layer block coefficients belonging to one or more zones that are removed are removed based upon a signal in the bit stream.

8. The method of claim 1, further comprising the step of periodically adding a macroblock to the video sequence based upon the base layer.

9. The method of claim 8, wherein the macroblock is added at designated intervals for at least one of the plurality of zones, and wherein the intervals are signaled within the bit stream.

10. The method of claim 8, wherein the macroblock is added periodically based upon characteristics of the video sequence, and wherein the macroblock is not signaled within the bit stream.

11. The method of claim 10, wherein the period for each of the plurality of zones may differ, and wherein different characteristics of the video sequence are used in calculating the period for each of the plurality of zones.

12. The method of claim 8, further comprising the step of decoding the base layer for use until a new macroblock is added.

13. A computer program product for providing quality scalability in a video stream, comprising:
computer code for providing a bit stream with a video sequence having a base layer and an enhancement layer, the enhancement layer including a plurality of enhancement layer blocks, each enhancement layer block having a plurality of layer block coefficients;
computer code for assigning each layer block coefficient to one of a plurality of zones; and
computer code for removing the layer block coefficients assigned to a particular one of the plurality of zones.

14. The computer program product of claim 13, wherein the number of layer block coefficients belonging to a zone is signaled within the bit stream.

15. The computer program product of claim 13, wherein the number of layer block coefficients belonging to a zone is determined dynamically based upon previously encoded or decoded data.

16. The computer program product of claim 13, wherein the layer block coefficients belonging to one or more zones are removed periodically.

17. The computer program product of claim 16, wherein the period according to which zones are removed differs by zone.

18. The computer program product of claim 13, wherein the layer block coefficients belonging to one or more zones that are removed are removed based upon previously encoded or decoded data.

19. The computer program product of claim 13, wherein the layer block coefficients belonging to one or more zones that are removed are removed based upon a signal in the bit stream.

20. The computer program product of claim 13, further comprising computer code for periodically adding a macroblock to the video sequence based upon the base layer.

21. The computer program product of claim 20, wherein the macroblock is added at designated intervals for at least one of the plurality of zones, and wherein the intervals are signaled within the bit stream.

22. The computer program product of claim 20, wherein the macroblock is added periodically based upon characteristics of the video sequence, and wherein the macroblock is not signaled within the bit stream.

23. The computer program product of claim 22, wherein the period for each of the plurality of zones may differ, and wherein different characteristics of the video sequence are used in calculating the period for each of the plurality of zones.

24. The computer program product of claim 20, further comprising computer code for decoding the base layer for use until a new macroblock is added.

25. An electronic device, comprising:
a memory unit; and
a processor for processing information stored on the memory unit, wherein the memory unit includes a computer program product for providing quality scalability in a video stream, comprising:
computer code for providing a bit stream with a video sequence having a base layer and an enhancement layer, the enhancement layer including a plurality of enhancement layer blocks, each enhancement layer block having a plurality of layer block coefficients;
computer code for assigning each layer block coefficient to one of a plurality of zones; and
computer code for removing the layer block coefficients assigned to a particular one of the plurality of zones.

26. The electronic device of claim 25, wherein the number of layer block coefficients belonging to a zone is signaled within the bit stream.

27. The electronic device of claim 25, wherein the number of layer block coefficients belonging to a zone is determined dynamically based upon previously encoded or decoded data.

28. The electronic device of claim 25, wherein the layer block coefficients belong to one or more zones are removed periodically.

29. The electronic device of claim 28, wherein the period according to which zones are removed differs by zone.

30. The electronic device of claim 25, wherein the layer block coefficients belonging to one or more zones that are removed are removed based upon previously encoded or decoded data.

31. The electronic device of claim 25, wherein the layer block coefficients that are removed are removed based upon a signal in the bit stream.

32. The electronic device of claim 25, wherein the computer program product further comprises computer code for periodically adding a macroblock to the video sequence based upon the base layer.

33. The electronic device of claim 32, wherein the macroblock is added at designated intervals for at least one of the plurality of zones, and wherein the intervals are signaled within the bit stream.

34. The electronic device of claim 32, wherein the macroblock is added periodically based upon characteristics of the video sequence, and wherein the macroblock is not signaled within the bit stream.

35. The electronic device of claim 34, wherein the period for each of the plurality of zones may differ, and wherein different characteristics of the video sequence are used in calculating the period for each of the plurality of zones.

36. The electronic device of claim 32, wherein the computer program product further comprises computer code for decoding the base layer for use until a new macroblock is added.
